(19) United States
(12) Patent Application Publication
(10) Pub. No.: US 2014/0241613 A1
(43) Pub. Date: Aug. 28, 2014

(54) COORDINATED STEREO IMAGE ACQUISITION AND VIEWING SYSTEM

(71) Applicant: Korea University Research and Business Foundation, (US)

(72) Inventors: Sang Hoon Sull, Seoul (KR); Hoon Jae Lee, Suwon (KR); Han Je Park, Gunpo (KR)

(73) Assignee: Korea University Research and Business Foundation

(21) Appl. No.: 13/780,163

(22) Filed: Feb. 28, 2013

(51) Int. Cl. G06T 7/00

(52) U.S. Cl. CPC G06T 7/002
USPC 382/154

(57) ABSTRACT

An image processing apparatus is provided, which includes a first calculation unit to calculate a first position of at least one first point sampled from an actual 3-dimensional (3D) object to be acquired as stereo 3D images, a second calculation unit to calculate a second position of at least one second point of a receiving end corresponding to the first point, using at least one second parameter related to the receiving end provided with the stereo 3D images, and a determination unit to determine at least one first parameter related to a transmission end to acquire and provide the stereo 3D images to the receiving end so that a difference between the first position and the second position is minimized.

### CROSS-REFERENCE TO RELATED APPLICATION

This application claims the benefit of Korean Patent Application No. 10-2013-0022279, filed on Feb. 28, 2013, in the Korean Intellectual Property Office, the disclosure of which is incorporated herein by reference.

### BACKGROUND

1. Field of the Invention

The present invention relates to realistic communication through stereo 3D images, and more particularly, generally relates to 3-dimensional video call, medical acts performed by watching 3D images of a diseased part of a patient, remote disposal of explosives, remote shopping, remote control of equipments, and the like.

2. Description of the Related Art

The growth of the 3D industry, such as stereo 3D TV and cameras, has led to a substantial increase in the research and development of 3D technology. One of important issues in the field of stereo 3D images is to provide a realistic 3D perception to a viewer. Here, the realistic remote 3D perception of a 3D object refers to a visual capability for perceiving a 3D object having same shape and/or size as an actual or real 3D object.

According to a conventional apparatus and method for acquiring stereo 3D images, a 3D object perceived by the viewer is different in a shape and/or a size from the actual 3D object. Due to the difference, the realistic 3D perception may not be provided to the viewer.

Accordingly, there is a demand for a method of minimizing the difference in the shape and/or the size between the 3D object perceived by the viewer and the actual 3D object, so as to provide the realistic 3D perception to the viewer.

Conventional methods for the realistic remote 3D perception, for example, include a technology of generating new stereo 3D images by reconstructing the 3D object based on an accurate disparity field estimation and adjusting the 3D object perceived by the viewer in a 3D space. Such a technology has been suggested by N. Chang, and A. Zakhor as disclosed in “View generation for three-dimensional scenes from video sequences,” IEEE Trans. Image Process., vol. 6, no. 4, pp. 584-598, April 1997, and by R. Vasudevan, G Kurillo, E. Lobaton, T. Bemardin, 0. Kreylos, R. Bajcsy, and K. Nahrstedt, as disclosed in “High-quality visualization for geographically distributed 3-D teleimmersive applications,” IEEE Trans. Multimedia, vol. 13, no. 3, pp. 573-584, June 2011.

However, despite the numerous attempts to find an ideal way to compute disparity fields, their estimation from stereo 3D images is still challenging due to inherent inaccuracies when calculating point correspondence even with intensive computation. Therefore, resultant stereo 3D images synthesized from incompletely reconstructed 3D objects may also be incomplete in comparison to the stereo 3D images being actually acquired.

Currently, the 3D depth control is also widely used in current commercial stereo displays such as 3D TVs, or on smartphones or cameras. In those devices, however, 3D depth adjustment is usually implemented by the conventional parallax adjustment method which just increases or decreases the horizontal disparities of an object or whole scene in the stereo 3D images by the same amount, a process which for the viewer results in visual fatigue and shape distortion in 3D space.

In addition, various existing documents including E Zilly, J. Kluger, and P. Kauff, “Production rules for stereo acquisition,” Proc. IEEE, vol. 99, no. 44, pp. 590-606, April 2011, have suggested a method of adjusting stereo camera parameters when acquiring the stereo 3D images in order to reduce excessive disparity and thereby reduce the visual fatigue.

However, as the stereo 3D images are being applied to more various and risky fields including medical application, precision machinery control, video conferences, remote shopping, and the like, not only reduction in the visual fatigue but also solution to reduce the distortion of the shape and/or the size of a 3D object perceived by the viewer is becoming important.

### SUMMARY

According to an aspect of the present invention, there is provided an image processing apparatus including a first calculation unit to calculate a first position of at least one first point sampled from an actual 3-dimensional (3D) object to be acquired as stereo 3D images, a second calculation unit to calculate a second position of at least one second point of a receiving end corresponding to the first point, using at least one second parameter related to the receiving end provided with the stereo 3D images, and a determination unit to determine at least one first parameter related to a transmission end to acquire and provide the stereo 3D images to the receiving end so that a difference between the first position and the second position is minimized.

At least one of the first position and the second position may be a relative position with respect to a reference position in a 3D space.

The at least one first parameter may include at least one selected from a baseline, a focal length, a convergence angle, a virtual baseline, and an acquisition distance (a distance between the actual 3D object and a camera) which are related to the transmission end.

The at least one second parameter may include at least one selected from a screen size, a viewing distance, a distance between eyes of a viewer, and a viewer position which are related to the receiving end.

The image processing apparatus may further include a first control unit to acquire the stereo 3D images by adjusting the camera related to the transmission end based on the at least one first parameter.

The image processing apparatus may further include a second control unit to receive the at least one second parameter from the receiving end and transfer the at least one second parameter to the second calculation unit.

The image processing apparatus may further include a second control unit to measure the at least one second parameter using at least one of the stereo 3D images and depth information, which are transmitted from the receiving end, and to transfer the at least one second parameter to the second calculation unit.

The determination unit may determine the at least one first parameter by obtaining a solution of an objective function that minimizes the difference between the first position and the second position.

The determination unit may obtain the solution of the objective function by selecting part of the at least one first point, when a number of the at least one first point being sampled is larger than a sum of a number of the at least one first parameter and a number of the at least one second parameter.

The determination unit may exclude at least one outlier when selecting the part of the at least one first point.

The second calculation unit may calculate the second position based on geometric image compensation so as to reduce a distortion resulting from a convergence angle of the camera related to the transmission end.

The determination unit may determine the at least one first parameter by adding at least one of a disparity control term and a parameter change control term to the objective function and obtaining a solution.

According to another aspect of the present invention, there is provided an image processing method including calculating a first position of at least one first point sampled from an actual 3D object to be acquired as stereo 3D images, calculating a second position of at least one second point of a receiving end corresponding to the first point, using at least one second parameter related to the receiving end provided with the stereo 3D images, and determining at least one first parameter related to a transmission end to acquire and provide the stereo 3D images to the receiving end so that a difference between the first position and the second position is minimized

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an image processing apparatus according to an embodiment of the present invention;

FIGS. 2A through 2D are diagrams illustrating a transmission end and a receiving end including the image processing apparatus of FIG. 1;

FIGS. 3A to 3C are diagrams illustrating a coordinated model of the transmission end for acquiring stereo 3D images and the receiving end for viewing the stereo 3D images, according to an embodiment of the present invention;

FIGS. 4A to 4C are diagrams illustrating estimation of a block disparity according to an embodiment of the present invention;

FIG. 5 is a diagram illustrating estimation of a first position, that is, a 3-dimensional (3D) coordinate of at least one first point sampled from an actual 3D object, according to an embodiment of the present invention;

FIGS. 6A and 6B are diagrams illustrating calculation of a second position, that is, a 3D coordinate of at least one second point in a 3D object perceived by a viewer with respect to camera parameters related to the transmission end, according to an embodiment of the present invention;

FIG. 7 is a diagram illustrating an acquisition of the stereo 3D images using stereo cameras having a convergence angle, according to an embodiment of the present invention; and

FIG. 8 is a flowchart illustrating an image processing method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

Terms used herein are selected to be generally known terms in consideration of functions related to the present invention, and may differ according to the intention of a user or operator, customs, or appearance of new techniques.

In a particular case, terms may be selected by the applicant for easy understanding or a convenient explanation and, in this case, the terms will be specifically defined in a proper part. Therefore, the definitions of the terms should be determined based on meaning of the terms and the entire specification rather than being understood simply as names of the terms.

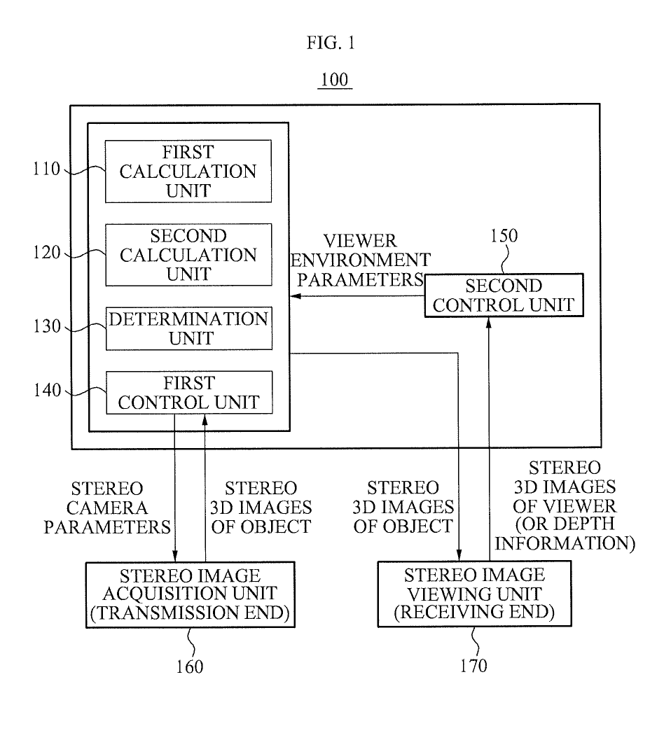

FIG. 1 is a block diagram of an image processing apparatus 100. At least one of a shape and a size of a 3-dimensional (3D) object perceived by a viewer through stereo 3D images may be influenced by various parameters of stereo cameras and a viewer environment, such as internal and external parameters of the stereo cameras, a size of a 3D stereo display screen, a viewing distance, and the like.

Therefore, the image processing apparatus 100 for providing a 3D scene using the stereo 3D images may control at least one of the shape and the size of the 3D object perceived by the viewer to be maintained equal to at least one of the shape and the size of an actual 3D object. For this, the image processing apparatus 100 may calculate optimal stereo camera parameters that minimize a difference between a first position, that is, position of at least one point sampled from the actual 3D object, that is, a first point, and a second position, that is, position of at least one point at the 3D object perceived by the viewer corresponding to the first point, that is, a second point. The optimal stereo camera parameters will be referred to as first parameters.

According to an embodiment, the image processing apparatus 100 may include a first calculation unit 110, a second calculation unit 120, a determination unit 130, a first control unit 140, and a second control unit 150.

The first calculation unit 110 may calculate the first position of at least one first point sampled from the actual 3D object. The second calculation unit 120 may calculate the second position of the at least one second point corresponding to the at least one first point in the 3D object perceived by the viewer, using at least one viewer environment parameter related to a receiving end 170. The viewer environment parameters will be referred to as second parameters. Here, the receiving end 170 may refer to a 3D stereo viewing system adapted to receive the stereo 3D images of the actual 3D object acquired by a transmission end 160 and display the stereo 3D images to the viewer. For example, the receiving end 170 may include a screen and a depth sensor. The transmission end 160 may include stereo 3D cameras capable of acquiring the stereo 3D images of the actual 3D object.

When the first parameters, that is, the optimal stereo camera parameters, are determined, the first control unit 140 of the image processing apparatus 100 may acquire the stereo 3D images of the actual 3D object by adjusting the stereo camera parameters related to the transmission end 160.

The second control unit 150 of the image processing apparatus 100 may receive the second parameters, that is, the viewer environment parameters including a screen size, the viewing distance, a distance between eyes of the viewer, a viewer position, and the like from the receiving end 170, and transmit the second parameters to the second calculation unit 120.

Furthermore, the second control unit 150 may measure the second parameters, that is, the viewer environment parameters including the viewing distance or the distance between eyes of the viewer, the viewer position, and the like, using at least one method of face detection and/or eye detection, based on the stereo cameras for acquiring stereo 3D images and/or a depth sensor using infrared (IR) and the like.

In another embodiment, the second control unit 150 may not measure the second parameters, that is, the viewer environment parameters, but transmit default values of the viewer environment parameters to the second calculation unit 120. For example, the second control unit 150 may transmit 75 mm as a default value of the distance between eyes of the viewer to the second calculation unit 120 when information on the distance between eyes of to the viewer is not received, when the distance between eyes of the viewer is hard to be measured, when a user orders to use the default value, or when use of the default value is determined to be proper for any reasons.

According to the embodiment, the determination unit 130 of the image processing apparatus 100 may determine at least one first parameter related to the transmission end 160 to minimize the difference between the first position and the second position. In addition, during determination of the first parameters, geometric image compensation may be performed to reduce the distortion of the 3D object perceived by the viewer resulting from a convergence angle of the stereo cameras. Such distortion is known as depth plane curvature. The geometric image compensation will be described in further detail with reference to the drawings.

The first parameters may be related to a camera acquiring the stereo 3D images to be provided to the receiving end 170. The first parameters may include at least one selected from a baseline, a focal length, a convergence angle, a virtual baseline, and an acquisition distance (a distance between the actual 3D object and the camera) which are related to the transmission end 160.

The second parameters may be related to the viewer environment in which the stereo 3D images are displayed to the viewer. For example, the second parameters may include at least one selected from the screen size, the viewing distance, the distance between eyes of the viewer, and the viewer position which are related to the receiving end 170 and may affect the shape and the size of the 3D object perceived by the viewer.

The determination unit 130 may determine at least one first parameter related to the transmission end 160 by obtaining a solution of an objective function for minimizing the difference between the first position and the second position. The at least one first parameter may be a parameter related to the stereo cameras included in the transmission end 160. Therefore, the first parameters determined by the determination unit 130 may be the to optimal stereo camera parameters.

At least one of the shape and the size of the 3D object perceived by the viewer represented by the stereo 3D images may be influenced by various stereo camera parameters and viewer environment parameters, including the internal and external parameters of the stereo cameras, the size of the 3D stereo display screen, the viewing distance, and the like. Therefore, the realistic 3D perception may be provided through adjustment of the first parameters. Although only the embodiments have been described related to the first parameters in relation to the stereo cameras, the viewer environment parameters, that is, the second parameters, may be adjusted according to circumstances to provide the realistic 3D perception to the viewer.

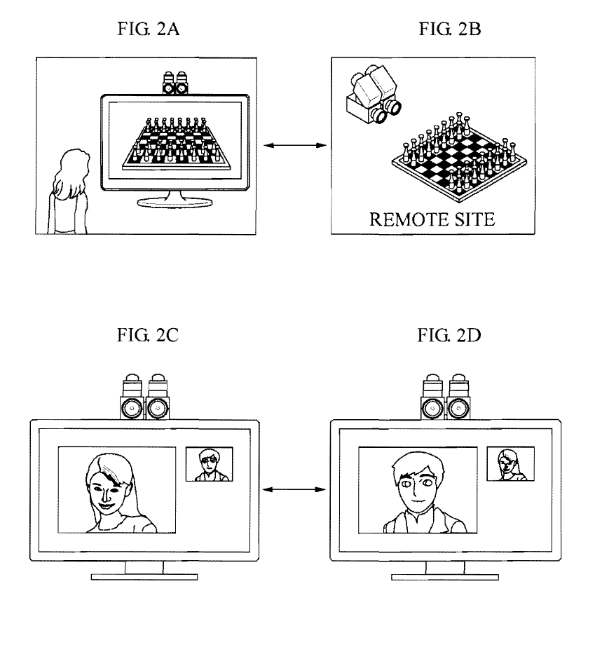

FIGS. 2A and 2B are diagrams illustrating the transmission end and the receiving end including the image processing apparatus 100 of FIG. 1. FIG. 2A shows an example in which stereo 3D images acquired using the first parameters related to the stereo cameras are transmitted to the viewer related to the receiving end and the viewer watches the stereo 3D images through a 3D stereo display screen.

FIG. 2B shows an example of video call using the image processing apparatus 100 although not limited to the video call. The transmission end described above may include a camera which acquires stereo 3D images, such as the stereo cameras, although not limited thereto. In addition, the receiving end may include the stereo cameras in the same manner as the transmission end. Therefore, the transmission end including the image processing apparatus 100 may be the receiving end, and vice versa.

According to the embodiment, both the transmission end and the receiving end may calculate the first position of the at least one first point sampled from the actual 3D object. Using at least one parameter related to the viewer environment of a counterpart, that is, the second parameter, the transmission end and the receiving end may calculate the second position corresponding to the at least one second point in the 3D object perceived by the counterpart.

In addition, at least one parameter related to a camera of the counterpart may be determined by obtaining the solution of the objective function that minimizes the difference between the first position and the second position. Accordingly, the optimal stereo camera parameters may be provided to each other. Thus, any one of the transmission end and the receiving end may include the image processing apparatus 100. However, in the present description, the transmission end and the receiving end will be separately described for a convenient explanation.

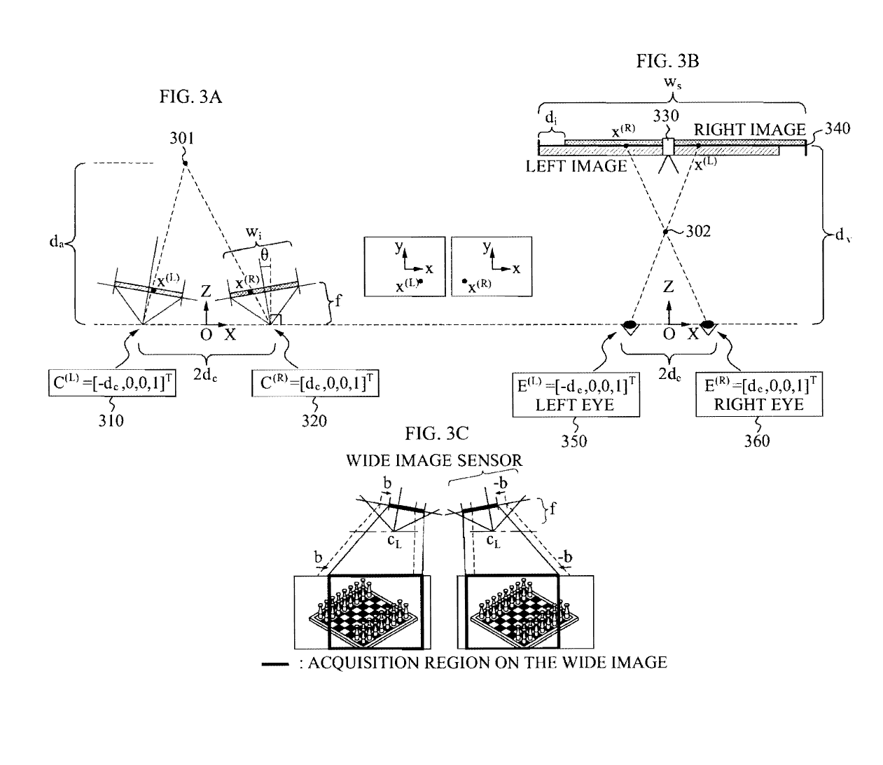

FIGS. 3A to 3C are diagrams illustrating a coordinated model of the transmission end for acquiring stereo 3D images and the receiving end for viewing the stereo 3D images, according to an embodiment of the present invention. FIG. 3A illustrates the transmission end for acquiring the stereo 3D images of a 3D object. FIG. 3B illustrates the receiving end for receiving and viewing the stereo 3D images of the 3D object, that is, the viewer environment. The transmission end shown in FIG. 3A may acquire the stereo 3D images of the 3D object using the stereo cameras. In addition, the acquired stereo 3D images of the 3D object may be transmitted to the receiving end shown in FIG. 3B and displayed on a display screen 340.

When the stereo 3D images are displayed on the display screen 340, a 3D point 302 of the 3D object perceived by the viewer may correspond to a 3D point 301 of the actual 3D object acquired as stereo 3D images by the stereo cameras of the transmission end. In FIG. 3, x^{(L)} and X^{(R)} denote 2D points at a left image and a right image corresponding to the point 301, respectively. Here, origins O of the transmission end and the receiving end are presumed to be a center point between a left camera C^{(L)} 310 and a right camera C^{(R)} 320 and a center point between a left eye E^{(L)} 350 and a right eye E^{(R)} 360 of the viewer, respectively.

In addition, it may be presumed that the origin O of the receiving end and a center point of the display screen 340 are aligned in a Z-direction. However, not limited to this to embodiment, the origin O of the receiving end may be set to another position.

The receiving end may obtain the second parameters, that is, the parameters related to the receiving end using the stereo cameras (or the 3D depth sensor) 330. The transmission end may apply the second parameters related to the receiving end in various manners. According to an embodiment, it may be presumed that the transmission end is aware of the second parameters, that is, the viewer environment parameters of the receiving end during acquisition of the stereo 3D images.

To acquire the stereo 3D images, the image processing apparatus 100 may estimate an optimal parameter of the stereo cameras of the transmission end, using the second parameter related to the receiving end in a state of knowing a depth of the actual 3D object. In this case, to know the depth of the actual 3D object, the first calculation unit 110 may calculate the first position of the at least one first point sampled from the actual 3D object. Although the first position of the at least one first point of the actual 3D object is calculated to obtain the first parameter related to the stereo cameras, the stereo 3D images which are transmitted to the receiving end may not be synthesized from the calculated first position of the actual 3D object. The stereo 3D images may be acquired by the stereo cameras, after the stereo camera parameter is adjusted using the first parameter related to the stereo cameras, where the first parameter determined by the image processing apparatus 100.

The optimal stereo camera parameters determined by the image processing apparatus 100 may be computed by minimizing the objective function defined as the difference between the first position of the at least one first point sampled from the actual 3D object and the second position of the at least one second point corresponding to the first point in the 3D object perceived by the viewer. Therefore, at least one of the shape and the size of the 3D object perceived by the viewer may be maintained equal to at least one of the shape and the size of the actual 3D object.

According to an embodiment, commercial stereo cameras having the fixed baseline and convergence angle may be used to acquire the stereo 3D images. In this case, an optimal baseline and focal length may be found by approximating a baseline variation to a virtual baseline variation based on a wide image that may be acquired from a horizontally wide image sensor. Adjustment of the virtual baseline will be described referring to FIG. 3C. The virtual baseline variation b may be defined as a horizontal position of the acquisition region within the horizontally wide image on the left image sensor in a left camera. A virtual baseline of a right camera may be adjusted symmetrically to the virtual baseline of the left camera.

The baseline refers to a distance between centers of two cameras, C^{(L)} and C^{(R)}. Adjustment of the baseline refers to adjustment of the distance between the centers C^{(L)} and C^{(R)}. When the stereo 3D images are acquired with the decreased baseline, the objects are viewed farther away from the viewer. Conversely, when the stereo 3D images are acquired with the increased baseline, the objects are viewed closer to the viewer.

Adjustment of the virtual baseline may be performed by moving the region acquiring the stereo 3D images on the image sensor in a horizontal direction. The stereo 3D images acquired through the adjustment of the virtual baseline may not be identical but may be similar to the stereo 3D images acquired through the adjustment of the actual baseline.

Presuming that the second parameters of the receiving end and the depth of the actual 3D object are known, in order to maintain the position, size, and shape of the 3D object perceived by the viewer to be equal to the position, size, and shape of the actual 3D object, the image processing apparatus 100 may obtain the first parameters p related to the stereo cameras, which minimizes the objective function J₁(p) defined as the difference between the first position Âₙ of the at least one first point sampled from the actual 3D object and the second positions v_{n,p} of the at least one second point of the 3D object perceived by the viewer, corresponding to the first point, using Equation 1.

$$\begin{matrix}\hat{p} = {arg min }_{p} {J}_{1} ( p ) \\ = {arg min }_{p} [ \frac{1}{N} {\sum }_{n = 1}^{N} {( {\hat{A}}_{n} - {V}_{n , p} )}^{2} ] ,\end{matrix} \qquad [ Equation 1 ]$$

In Equation 1, p denotes the first parameters related to the stereo cameras, and N denotes a number of the first points sampled from the actual 3D object.

According to another embodiment, to maintain the size and shape of the 3D object perceived by the viewer to be equal to the size and shape of the actual 3D object irrespective of the position of the actual 3D object, the image processing apparatus 100 may obtain the first parameters p related to the stereo cameras, which minimizes the objective function J₂(p) defined as the difference between a relative position Ãₙ of Âₙ with respect to a reference position Āₙ in a 3D space and a relative position \tilde{V}_{n,p} of V_{n,p} with respect to a reference position V̅_{n,p} in the 3D space, using Equation 2.

$$\begin{matrix}\hat{p} = {arg min }_{p} {J}_{2} ( p ) \\ = {arg min }_{p} [ \frac{1}{N} {\sum }_{n = 1}^{N} {( {\tilde{A}}_{n} - {\tilde{V}}_{n , p} )}^{2} ] ,\end{matrix} \qquad [ Equation 2 ]$$

Here, the reference positions Āₙ and V̅_{n,p} may denote average positions of Âₙ and V_{n,p}, for example. In this case, Āₙ and V̅_{n,p} may be calculated using Equation 3.

$${\tilde{A}}_{n} = {\hat{A}}_{n} - {\overline{A}}_{n} where {\overline{A}}_{n} = \frac{1}{N} {\sum }_{n = 1}^{N} {\hat{A}}_{n} , \\ {\tilde{V}}_{n , p} = {V}_{n , p} - {\overline{V}}_{n , p} where {\overline{V}}_{n , p} = \frac{1}{N} {\sum }_{n = 1}^{N} {V}_{n , p} . \qquad [ Equation 3 ]$$

According to another embodiment, to maintain the shape of the 3D object perceived by the viewer to be equal to the shape of the actual 3D object irrespective of the position and size of the actual 3D object, the image processing apparatus 100 may obtain the first parameters p related to the stereo cameras, which minimizes an object function J₃(p, s) to defined as the difference between Ãₙ and a product of \tilde{V}_{n,p} and a scale factor s, using Equation 4.

$$\begin{matrix}\hat{p} , \hat{s} = {arg min }_{p , s} {J}_{3} ( p , s ) \\ = {arg min }_{p , s} [ \frac{1}{N} {\sum }_{n = 1}^{N} {( {\tilde{A}}_{n} - s \cdot {\tilde{V}}_{n , p} )}^{2} ] ,\end{matrix} \qquad [ Equation 4 ]$$

Here, Ãₙ and \tilde{V}_{n,p} may be calculated using Equation 3.

According to another embodiment, the image processing apparatus 100 may obtain the first parameters p related to the stereo cameras, so that a visual fatigue induced by an excessive distance from the 3D stereo display screen to the 3D object perceived by the viewer is reduced. For example, the excessive distance from the 3D stereo display screen to the 3D object perceived by the viewer may result in an excessive disparity in the stereo 3D images, thereby causing visual discomfort to the viewer. Especially when the distance between the viewer and the object is shorter than the distance between the viewer and the 3D stereo display screen, the visual discomfort may be increased.

Accordingly, the image processing apparatus 100 may obtain the first parameters p related to the stereo cameras, which minimizes an objective function J₄(p) obtained by adding an additional term defined as a weighted sum of the distances between the 3D stereo display screen and the points of the 3D object perceived by the viewer, using Equation 5. The additional term will be referred to as a ‘disparity control term.’

$$\begin{matrix}\hat{p} = {arg min }_{p} {J}_{4} ( p ) \\ = {arg min J ( p ) + {w}_{d} \cdot }_{p} [ \frac{1}{N} {\sum }_{n = 1}^{N} {w}_{n} \cdot {( {d}_{v} - {Z}_{n , p}^{( v )} )}^{2} ]\end{matrix} \qquad [ Equation 5 ]$$

Here, w_{d} denotes a weight with respect to the additional term, dᵥ denotes a viewing distance, that is, the distance from the viewer to the 3D stereo display screen, and wₙ denotes a weight with respect to a distance from the 3D stereo display screen to an n-th point V_{n,p}=[X_{n,p}^{(V)},Y_{n,p}^{(V)},Z_{n,p}^{(V)}]^{T} at the 3D object perceived by the viewer. J(p) may be one of J₁(p), J₂(p), and J₃(p) in Equations 1, 2, and 4.

The weight wₙ may be set differently according to a position of a point V_{n,p} at the 3D object perceived by the viewer. For example, when the point V_{n,p} is located farther than the 3D stereo display screen (Z_{n,p}^{(V)}>dᵥ), the weight wₙ may be set to a small value so that most of the 3D object perceived by the viewer are viewed farther than the 3D stereo display screen, considering that a visual fatigue caused by an object closer than the 3D stereo display screen is greater than a visual fatigue caused by an object farther than the 3D stereo display screen.

According to another embodiment, when consecutive stereo 3D images are acquired, the image processing apparatus 100 may obtain the smoothly varying first parameters p related to the stereo cameras, so that the visual fatigue caused by an abrupt change of the stereo camera parameters is reduced. For example, when the image processing apparatus 100 acquires stereo 3D images, the optimal first parameters p may be found for each frame. In this case, however, the visual fatigue of the viewer may be increased if the optimal first parameters in p may abruptly change along with the time during acquisition of the consecutive stereo 3D images.

Therefore, the image processing apparatus 100 may obtain the first parameters p related to the stereo cameras, which minimizes an objective function J₅(p) obtained by adding an additional term defined as cost (or penalty) with respect to the change of the parameters in p along with the time, using Equation 6. The additional term may be referred to as ‘parameter change control term.’

$$\begin{matrix}{\hat{p}}_{t} = {arg min }_{{p}_{t}} {J}_{5} ( p ) \\ = {arg min J ( p ) + }_{{p}_{t}} {w}_{p} \cdot {( {p}_{t} - {\hat{p}}_{t - 1} )}^{2} ,\end{matrix} \qquad [ Equation 6 ]$$

Here, wₚ denotes a weight with respect to the additional term, and pₜ denotes the first parameters at time t. J(p) may be one of J₁(p), J₂(p), and J₃(p) in Equations 1, 2, and 4.

According to another embodiment, the image processing apparatus 100 may obtain the first parameters pₜ related to the stereo cameras, which minimizes an objective function defined as a weighted sum of the objective functions J₁(p), J₂(p), J₃(p), J₄(p), and J₅(p) of Equations 1, 2, 4, 5, and 6, using Equation 7.

$$\begin{matrix}{\hat{p}}_{t} , s = {arg min }_{{p}_{t} , s} J ( {p}_{t} , s ) \\ = {arg min }_{{p}_{t} , s} {w}_{1} \cdot {J}_{1} ( {p}_{t} ) + {w}_{2} \cdot {J}_{2} ( {p}_{t} ) + {w}_{3} \cdot {J}_{3} ( {p}_{t} , s ) + \\ {w}_{d} \cdot [ \frac{1}{N} {\sum }_{n = 1}^{N} {w}_{n} \cdot {( {d}_{v} - {Z}_{n , {p}_{t}}^{( V )} )}^{2} ] + {w}_{p} \cdot {( {p}_{t} - {\hat{p}}_{t - 1} )}^{2} .\end{matrix} \qquad [ Equation 7 ]$$

Here, w₁, W₂, and w₃ denote the weights of J₁(pₜ), J₂(P), and J₃(P), respectively.

In Equation 7, the weights w₁, w₂, w₃, w_{d}, and wₚ may be adjusted to various values. For example, the weights w₂, w₃, w_{d}, and wₚ excluding w₁ may be set to zero to obtain the first parameters related to the stereo cameras, using only J₁(pₜ). As another example, w_{d} may be set to relatively larger value in order to reduce the visual fatigue caused by the excessive distance between the 3D stereo display screen and the 3D object perceived by the viewer.

According to an embodiment, optimization may be used as a method for minimizing the object functions of Equations 1 to 7. The optimization may be performed through various methods, for example, an exhaustive or partial search method in a discrete search space of p, a non-linear optimization method such as the Newton's method, optimization by approximating Equations, and the like. When the objective functions are defined in different manners from the foregoing description, optimization may be applied to maximize the corresponding objective functions.

When obtaining the solutions of the objective functions of Equations 1 to 7, the number N of the first points sampled from the actual 3D object may be set larger than a number of the parameters p, to thereby prevent the minimization problem from being an underdetermined problem. For example, when p includes eight parameters related to the transmission end and the receiving end, that is, the first parameters and the second parameters denoted by d_{c}, θ, b, f, dₐ wᵢ, wₛ, and d, in the embodiment shown in FIG. 3, the minimization of Equations 1 to 7 may be solved using coordinates of at least eight sampling points of the actual 3D object.

When the number N of the first points is sufficiently larger than the number of the parameters p, the solutions of the objective functions of Equations 1 to 7 may be obtained using only part of the sampling points of the actual 3D object. In this case, a random sample consensus (RANSAC) method may be used to remove outliers, and use only reliable first positions of the first points sampled from the actual 3D object.

In general, during minimization of the objective functions of Equations 1 to 7, the first parameters, which are the stereo camera parameters, may include a baseline (d_{c}), a focal length (f), a convergence angle (θ), a virtual baseline (b), and an acquisition distance (dₐ, a distance between the actual 3D object and the camera) (p={d_{c}, f, θ, b, dₐ}). When the to stereo cameras of which the baseline and the convergence angle are fixed, the parameters p may include only the virtual baseline, the focal distance, and the acquisition distance (p={b, f, dₐ}).

According to an embodiment, when the solutions for minimizing the objective functions of Equations 1 to 7 are obtained, in other words, when the first parameters as the optimal stereo camera parameters are determined, the first parameters related to the stereo cameras of the transmission end may be adjusted to the optimal stereo camera parameters, then acquiring new stereo 3D images. Therefore, at least one of the shape and the size of the 3D object perceived by the viewer may be maintained equal to at least one of the shape and the size of the actual 3D object.

To perceive an enlarged or reduced 3D object, a particular focal length, that is, a zoom level, may be specified by the viewer or a stereo camera user related to the transmission end. Here, the image processing apparatus 100 may determine the focal length within a limited search space around the specified focal length. In addition, when one 3D object is specified in the stereo 3D images and a part of the object is selected manually or by existing object segmentation methods, Âₙ and V_{n,p} may be calculated with respect to only the specified (part of) 3D object during minimization of Equations 1 to 7.

Hereinafter, a calculation process for determining the optimal stereo camera parameters by the image processing apparatus 100 will be described in further detail. Coordinates of points in 2D and 3D spaces will be expressed by homogeneous coordinates.

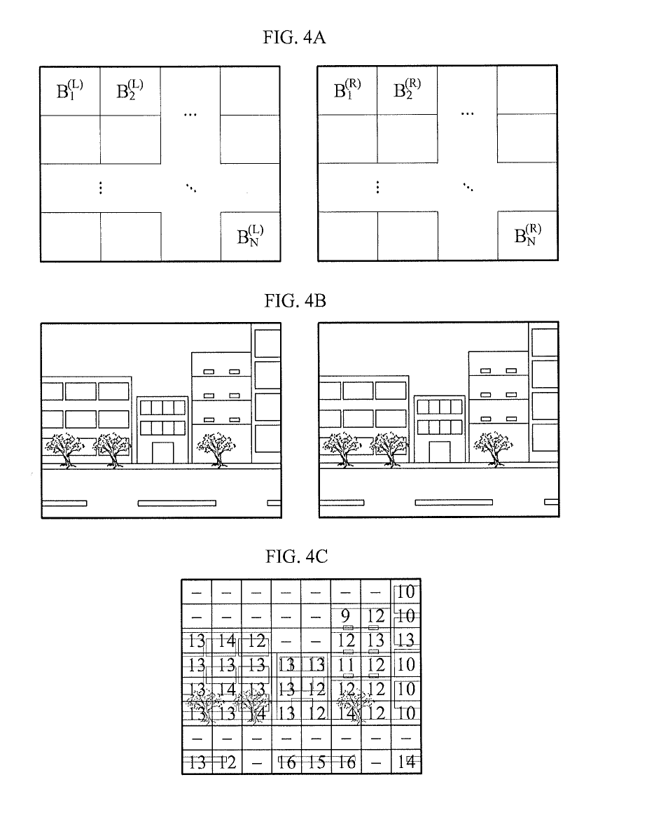

FIGS. 4A to 4C are diagrams illustrating estimation of a block disparity according to an embodiment of the present invention. According to the embodiment, to calculate the first position Âₙ of the at least one first point sampled from the actual 3D object, disparities in input preview stereo 3D images may be estimated in units of an image block pair. Next, the first position of the at least one first point in the actual 3D object may be calculated using the estimated disparities.

Alternatively, based on feature point extraction, a pair of corresponding points in a left image and a right image shown in FIG. 4B may be found. Then, the first position of the at least one first points in the actual 3D object may be estimated from the disparities of the corresponding points.

According to the embodiment, it may be presumed that the left image and the right image of the preview stereo 3D images as shown in FIG. 4B are divided into N-number of image blocks as shown in FIG. 4A. In this case, Bₙ^{(L)} and Bₙ^{(R)} may denote a set of pixels in an n-th image block of the left and the right images, respectively. Then, a block disparity dₙ corresponding to the n-th image block pair may be estimated based on horizontal block matching, using Equation 8.

$${d}_{n} = {arg min}_{{K}_{min} \leq k \leq {K}_{max}} [ {\sum }_{x , y ∈ {B}_{a}^{( L )}}^{ } {( {f}_{x , y}^{( L )} - {f}_{x - k , y}^{( R )} )}^{2} ] \qquad [ Equation 8 ]$$

In this case, ƒ_{x,y}^{(L)} and ƒ_{x,y}^{(R)} denote pixel values at [x,y,1]^{T} in the left and right images, respectively, and Kₘᵢₙ and Kₘₐₓ denote search ranges. FIG. 4C shows an example of the block disparity estimation result. The foregoing block disparity estimation method may not be effective with regard to an image block having low texture. Therefore, the block disparity estimation may not be performed for the image blocks having low texture, where low-textured image blocks are denoted by “-” in FIG. 4.

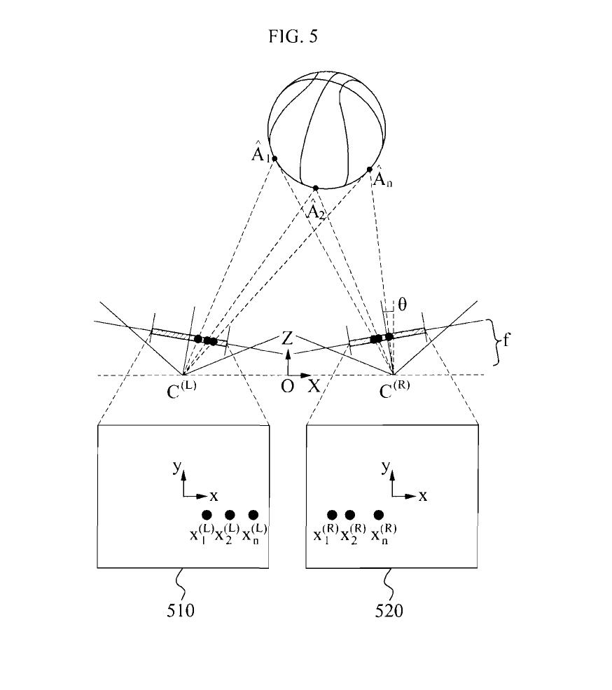

FIG. 5 is a diagram illustrating estimation of the first position of the at least one first point sampled from the actual 3D object. Referring to FIG. 5, when the block disparity dₙ is estimated with respect to the image block pair of the above-described stereo 3D images, a 3D position of the first position Âₙ of the first point sampled from the actual 3D object may be calculated as in Equation 9.

$${\hat{A}}_{n} = {arg max}_{{A}_{n}} [ {\prod }_{j ∈ ( L , R )}^{ } Pr ( {x}_{n}^{( j )} \vert {A}_{n} , {Λ}^{( j )} , {Ω}^{( j )} , {τ}^{( j )} ) ] \qquad [ Equation 9 ]$$

Here, j denotes a left or right camera index, xₙ^{(j)}=[xₙ^{(j)}, yₙ^{(j)},1]^{T} denotes a 2D coordinate of the n-th image block in the left or right image (in this case, xₙ^{(R)}=xₙ^{(L)}−dₙ), Λ^{(j)} denotes an intrinsic matrix of the left or right camera, and Ω^{(j)} and τ^{(j)} denote rotation and translation matrices of the left or right camera, respectively, which compose an extrinsic matrix of the left or right camera.

In Equation 9, when intrinsic and extrinsic matrices {Λ^{(j)},Ω^{(j)}, τ^{(j)}} and Aₙ are given, the likelihood Pr(xₙ^{(j)}|Aₙ, Λ^{(j)}, Ω^{(j)}, τ^{(j)}) for observing a coordinate xₙ^{(j)} on the image may be expressed by Equation 10, using a pinhole camera model including an additive noise that is normally distributed with a spherical covariance.

$$Pr ( {x}_{n}^{( j )} \vert {A}_{n} , {Λ}^{( j )} , {Ω}^{( j )} , {τ}^{( j )} ) = {Norm}_{{x}_{n}^{( j )}} [ pinhole [ {A}_{n} , {Λ}^{( j )} , {Ω}^{( j )} , {τ}^{( j )} ] , {σ}^{2} I ] \qquad [ Equation 10 ]$$

Here, Normₓ [μ, Σ] denotes multivariate normal distribution with the mean μ and covariance Σ, and σ² denotes variance of noise. The pinhole camera model may be expressed as show in Equation 11.

$$pinhole [ {A}_{n} , Λ , Ω , τ ] = Λ [ \begin{matrix}Ω & τ\end{matrix} ] {A}_{n} = [ \begin{matrix}{r}_{1} f & γ & {δ}_{x} \\ 0 & {r}_{1} f & {δ}_{y} \\ 0 & 0 & 1\end{matrix} ] [ \begin{matrix}cos θ & 0 & sin θ & - {d}_{c} cos θ \\ 0 & 1 & 0 & 0 \\ - sin θ & 0 & cos θ & {d}_{c} sin θ\end{matrix} ] {A}_{n} \qquad [ Equation 11 ]$$

Here, r₁ denotes a down-scaling factor for the image sensor to transform a 3D space coordinate to an image coordinate. To simplify calculation, a skew parameter γ and image offset parameters δₓ and δ_{y} with with respect to x and y directions may be presumed to be zeroes.

After calculation of the 3D position of Âₙ , the relative position Ãₙ of Âₙ with to respect to the reference position in the 3D space may be calculated using Equation 3.

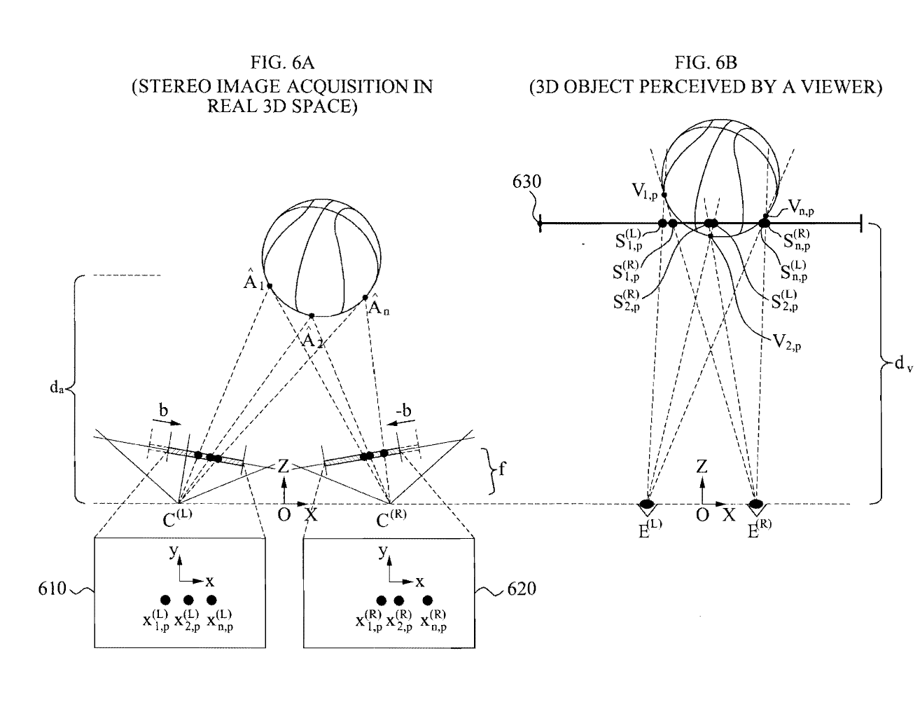

FIGS. 6A and 6B are diagrams illustrating calculation of the second position of the at least one second point in the 3D object perceived by the viewer with respect to the camera parameters, according to an embodiment of the present invention.

According to the embodiment, after the 3D position Âₙ of a point sampled from the actual 3D object is calculated and then Ãₙ corresponding to Âₙ is calculated, a solution for minimizing the one of the objective functions of Equations 1 to 7 may be obtained so that at least one of the shape and the size of the 3D object perceived by the viewer is maintained equal to at least one of the shape and the size of the actual 3D object. By obtaining the solution, the first parameters p related to the stereo cameras may be determined. For this, a method of calculating \tilde{V}_{n,p} for a given p will be described with reference to FIG. 6.

FIG. 6A shows the actual 3D object at the transmission end. FIG. 6B shows the 3D object perceived by the viewer at the receiving end. In FIG. 6A, for a given set of the first parameters p related to the stereo cameras, a point Âₙ is projected to a left image 610 and a right image 620 as x_{n,p}^{(L)} and x_{n,p}^{(R)}, respectively. x_{n,p}^{(L)} and x_{n,p}^{(R)} may be expressed as shown in Equation 12 from Âₙ calculated by Equation 8, using the pinhole camera model of Equation 11.

$$\begin{matrix}{x}_{n , p}^{( L )} = {T}_{b}^{( L )} [ pinhole [ {\hat{A}}_{n} , {Λ}_{p}^{( L )} , {Ω}_{p}^{( L )} , {τ}_{p}^{( L )} ] ] \\ = {T}_{b}^{( L )} {Λ}_{p}^{( L )} [ \begin{matrix}{Ω}_{p}^{( L )} & {τ}_{p}^{( L )}\end{matrix} ] {\hat{A}}_{n} ,\end{matrix} \\ \begin{matrix}{x}_{n , p}^{( R )} = {T}_{b}^{( R )} [ pinhole [ {\hat{A}}_{n} , {Λ}_{p}^{( R )} , {Ω}_{p}^{( R )} , {τ}_{p}^{( R )} ] ] \\ = {T}_{b}^{( R )} {Λ}_{p}^{( R )} [ \begin{matrix}{Ω}_{p}^{( R )} & {τ}_{p}^{( R )}\end{matrix} ] {\hat{A}}_{n} ,\end{matrix} \\ ( {T}_{b}^{( L )} = [ \begin{matrix}1 & 0 & b \\ 0 & 1 & 0 \\ 0 & 0 & 1\end{matrix} ] , {T}_{b}^{( R )} = [ \begin{matrix}1 & 0 & - b \\ 0 & 1 & 0 \\ 0 & 0 & 1\end{matrix} ] . ) \qquad [ Equation 12 ]$$

In this case, Λₚ^{(j)}, Ωₚ^{(j)} and τₚ^{(j)} denote an intrinsic matrix, a rotation matrix and translation matrix of the left or right camera for a given set of the first parameters p related to the stereo cameras, respectively. T_{b}^{(j)} denotes a transformation matrix for adjustment of a virtual baseline of the stereo 3D images.

After x_{n,p}^{(L)} and x_{n,p}^{(R)} are calculated, the geometric image compensation for reducing a distortion of the 3D object perceived by the viewer, caused by the convergence angle of the stereo camera, may be performed as expressed by Equation 13.

$$\begin{matrix}{x}_{n , p}^{( cL )} = {T}_{c}^{( L )} {x}_{n , p}^{( L )} , \\ = {T}_{c}^{( L )} {T}_{b}^{( L )} {Λ}_{p}^{( L )} [ \begin{matrix}{Ω}_{p}^{( L )} & {τ}_{p}^{( L )}\end{matrix} ] {\hat{A}}_{n} ,\end{matrix} \\ \begin{matrix}{x}_{n , p}^{( cR )} = {T}_{c}^{( R )} {x}_{n , p}^{( R )} , \\ = {T}_{c}^{( R )} {T}_{b}^{( R )} {Λ}_{p}^{( R )} [ \begin{matrix}{Ω}_{p}^{( R )} & {τ}_{p}^{( R )}\end{matrix} ] {\hat{A}}_{n} ,\end{matrix} \\ ( {T}_{c}^{( L )} = [ \begin{matrix}{c}^{( L )} {\vert}_{( - θ ) , {x}_{n , p}^{( L )}} & 0 & 0 \\ 0 & 1 & 0 \\ 0 & 0 & 1\end{matrix} ] , {T}_{c}^{( R )} = [ \begin{matrix}{c}^{( R )} {\vert}_{θ , {x}_{n , p}^{( R )}} & 0 & 0 \\ 0 & 1 & 0 \\ 0 & 0 & 1\end{matrix} ] . ) \qquad [ Equation 13 ]$$

Here, T_{c}^{(j)} denotes the transformation matrix for the geometric image compensation in the stereo 3D images, and c^{(j)}|_{θ,x}_{_{n,p}}(j) denotes a compensation variable determined by the convergence angle θ and a x-coordinate x_{n,p}^{(j)} of x_{n,p}^{(j)}. In FIG. 6B, when the stereo 3D images are displayed on the 3D stereo display screen, 3D points S_{n,p}^{(L)} and S_{n,p}^{(R)} on the 3D stereo display screen, corresponding to x_{n,p}^{(cL)} and x_{n,p}^{(cR)}, respectively, may be calculated by Equation 14.

$$\begin{matrix}{S}_{n , p}^{( L )} = λ [ {X}_{n , p}^{( SL )} , {Y}_{n , p}^{( SL )} , {Z}_{n , p}^{( SL )} , 1 ] = {T}_{s} {x}_{n , p}^{( cL )} \\ = {T}_{s} {T}_{c}^{( L )} {T}_{b}^{( L )} {Λ}_{p}^{( L )} [ \begin{matrix}{Ω}_{p}^{( L )} & {τ}_{p}^{( L )}\end{matrix} ] {\hat{A}}_{n} ,\end{matrix} \\ \begin{matrix}{S}_{n , p}^{( R )} = λ [ {X}_{n , p}^{( SR )} , {Y}_{n , p}^{( SR )} , {Z}_{n , p}^{( SR )} , 1 ] = {T}_{s} {x}_{n , p}^{( cR )} \\ = {T}_{s} {T}_{c}^{( R )} {T}_{b}^{( R )} {Λ}_{p}^{( R )} [ \begin{matrix}{Ω}_{p}^{( R )} & {τ}_{p}^{( R )}\end{matrix} ] {\hat{A}}_{n} ,\end{matrix} \\ ( {T}_{s} = [ \begin{matrix}{r}_{2} & 0 & {r}_{2} \cdot {δ}_{x} \\ 0 & {r}_{2} & {r}_{2} \cdot {δ}_{y} \\ 0 & 0 & {d}_{v} \\ 0 & 0 & 1\end{matrix} ] . ) \qquad [ Equation 14 ]$$

Here, r₂ and Tₛ denote a screen magnification factor and a transformation matrix to transform an image coordinate to a 3D space coordinate, respectively. The image offset parameters δₓ and δ_{y} may may be presumed to be zero. In FIG. 6B, 3D positions of a left eye and a right eye of the viewer may be expressed as E^{(L)}=[−dₑ,0,0,1]^{T} and E^{(R)}=[dₑ,0,0,1]^{T}, respectively. Then, the second position V_{n,p} of the second point at the 3D object perceived by the viewer corresponding to Âₙ can be obtained by calculating the intersection of the ray from S_{n,p}^{(L)} to E^{(L)} and the ray from S_{n,p}^{(L)} to E^{(R)}, as expressed by Equation 15.

$$\begin{matrix}{V}_{n , p} = λ [ {X}_{n , p}^{( V )} , {Y}_{n , p}^{( V )} , {Z}_{n , p}^{( V )} , 1 ] = {T}_{v}^{( L )} {S}_{n , p}^{( L )} + {T}_{v}^{( R )} {S}_{n , p}^{( R )} , \\ = ( \begin{matrix}{T}_{v}^{( L )} {T}_{s} {T}_{c}^{( L )} {T}_{b}^{( L )} {Λ}_{p}^{( L )} [ \begin{matrix}{Ω}_{p}^{( L )} & {τ}_{p}^{( L )}\end{matrix} ] + \\ {T}_{v}^{( R )} {T}_{s} {T}_{c}^{( R )} {T}_{b}^{( R )} {Λ}_{p}^{( R )} [ \begin{matrix}{Ω}_{p}^{( R )} & {τ}_{p}^{( R )}\end{matrix} ]\end{matrix} ) {\hat{A}}_{n} , \\ = {T}_{p} {\hat{A}}_{n} .\end{matrix} \\ ( {T}_{v}^{( L )} = [ \begin{matrix}{d}_{e} & 0 & 0 & 0 \\ 0 & {d}_{e} & 0 & 0 \\ 0 & 0 & {d}_{e} & 0 \\ 1 & 0 & 0 & {d}_{e}\end{matrix} ] , {T}_{v}^{( R )} = [ \begin{matrix}{d}_{e} & 0 & 0 & 0 \\ 0 & {d}_{e} & 0 & 0 \\ 0 & 0 & {d}_{e} & 0 \\ - 1 & 0 & 0 & {d}_{e}\end{matrix} ] , {T}_{p} = {T}_{v}^{( L )} {T}_{s} {T}_{c}^{( L )} {T}_{b}^{( L )} {Λ}_{p}^{( L )} [ \begin{matrix}{Ω}_{p}^{( L )} & {τ}_{p}^{( L )}\end{matrix} ] + {T}_{v}^{( R )} {T}_{s} {T}_{c}^{( R )} {T}_{b}^{( R )} {Λ}_{p}^{( R )} [ \begin{matrix}{Ω}_{p}^{( R )} & {τ}_{p}^{( R )}\end{matrix} ] . ) \qquad [ Equation 15 ]$$

Here, Tᵥ^{(j)} denotes a transformation matrix to obtain V_{n,p} from S_{n,p}^{(j)}. In Equation 15, if Tₚ is once calculated for a given set of the first parameters p related to the stereo cameras, V_{n,p} with respect to every n may be calculated using the calculated Tₚ. Then, \tilde{V}_{n,p} denoting a relative position of v_{n,p} with respect to the reference position V̅_{n,p} in the 3D space may be calculated using Equation 3. Here, V̅_{n,p} may be expressed using Ā_{n and T}ₚ as Equation 16.

$${\overline{V}}_{n , p} = \frac{1}{N} {\sum }_{n = 1}^{N} {V}_{n , p} = {T}_{p} {\overline{A}}_{n} \qquad [ Equation 16 ]$$

Once Âₙ is calculated, the first parameters \hat{p} to that minimizes the objective function may be found by calculating \tilde{V}_{n,p} for a given set of the first parameters p related to the stereo cameras during minimization of Equations 1 to 7.

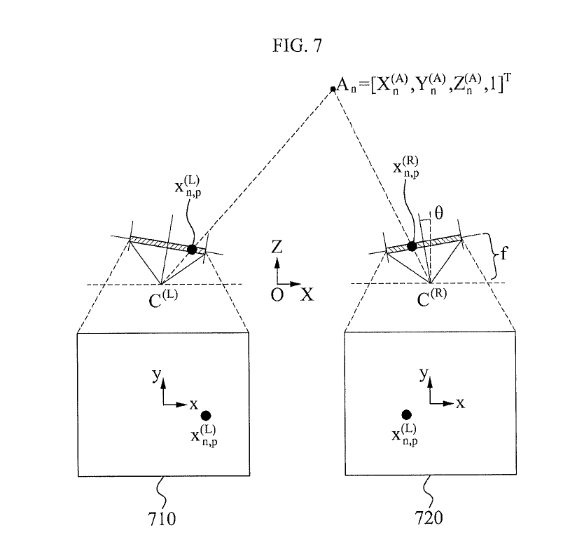

FIG. 7 is a diagram illustrating an acquisition of the stereo 3D images using the stereo cameras having a convergence angle, according to an embodiment of the present invention.

When the stereo images are acquired using the stereo cameras having the convergence angle, a 3D object perceived by the viewer represented by the stereo 3D images may have a depth plane curvature. As a method for reducing the depth plane curvature without dense disparity estimation or 3D reconstruction, the geometric image compensation may be applied.

In a case in which the position of the second point V_{n,p} in the 3D object perceived by the viewer, that is, the second position, is calculated during minimization of the objective functions of Equations 1 to 7, the geometric image compensation may be performed using Equation 13. Also, the geometric image compensation may be applied to all pixels of the stereo 3D images already acquired, thereby reducing a distortion of the 3D object perceived by the viewer.

An embodiment of the geometric image compensation will now be described. FIG. 7 illustrates the acquisition of the stereo 3D images using the stereo cameras having the convergence angle. A 3D position of a right camera will be denoted by C^{(R)}=[d_{c},0,0,1]^{T}. When the stereo 3D images are acquired, presuming that a point Aₙ=[Xₙ^{(A)},Yₙ^{(A)},Zₙ^{(A)},1]^{T} of the actual 3D object is projected to a 2D point x_{n,p}^{(R)} on a right image 720 for a given set of the first parameters p of the stereo cameras, a coordinate of x_{n,p}^{(R)} may be expressed using the pinhole camera model as shown in Equation 17.

$${x}_{n , p}^{( R )} = {λ [ {x}_{n , p}^{( R )} , {y}_{n , p}^{( R )} , 1 ]}^{T} = pinhole [ {A}_{n} , {Λ}^{( R )} , {Ω}^{( R )} , {τ}^{( R )} ] = {Λ}^{( R )} [ \begin{matrix}{Ω}^{( R )} & {τ}^{( R )}\end{matrix} ] {A}_{n} = [ \begin{matrix}{r}_{1} f & γ & {δ}_{x} \\ 0 & {r}_{1} f & {δ}_{y} \\ 0 & 0 & 1\end{matrix} ] [ \begin{matrix}cos θ & 0 & sin θ & - {d}_{c} cos θ \\ 0 & 1 & 0 & 0 \\ - sin θ & 0 & cos θ & {d}_{c} sin θ\end{matrix} ] {A}_{n} , \qquad [ Equation 17 ]$$

Also, an x-coordinate x_{n,p}^{(R)} of x_{n,p}^{(R)} may be calculated from Equation 17 by Equation 18 as follows.

$${x}_{n , p}^{( R )} = \frac{{r}_{1} f ( ( {X}_{n , p}^{( A )} - {d}_{c} ) cos θ + {Z}_{n , p}^{( A )} sin θ )}{{Z}_{n , p}^{( A )} cos θ - ( {X}_{n , p}^{( A )} - {d}_{c} ) sin θ} \qquad [ Equation 18 ]$$

In this case, Λ^{(R)} denotes an intrinsic matrix of the right camera, and Ω^{(R)} and τ^{(R)} denote rotation and translation matrices of the right camera, respectively, which compose an extrinsic matrix of the right camera. In the intrinsic matrix, a skew parameter γ and image offset parameters δₓ, and δ_{y} and with with respect to x and y directions may be presumed to be zero.

Let T_{c}^{(j)} denotes a transformation matrix for the geometric image compensation in a stereo 3D images for reducing the distortion resulting from the convergence angle. The geometric image compensation at the right image 720 may be performed by transforming a coordinate x_{n,p}^{(R)} into x_{n,p}^{(cR)} through T_{c}^{(R)} using Equation 19.

$${x}_{n , p}^{( cR )} = {T}_{c}^{( R )} {x}_{n , p}^{( R )} , \\ ( {T}_{c}^{( R )} = [ \begin{matrix}{c}^{( R )} {\vert}_{θ , {x}_{n , p}^{( R )}} & 0 & 0 \\ 0 & 1 & 0 \\ 0 & 0 & 1\end{matrix} ] . ) \qquad [ Equation 19 ]$$

In this case, c^{(j)}|_{θ,x}_{_{n,p}}(j) denotes a compensation variable at the right image determined by the convergence angle θ and the x-coordinate x_{n,p}^{(R)} of X_{n,p}^{(R)}, and is defined as (x_{n,p}^{(R)}|_{θ=0})/(x_{n,p}^{(R)}). Here, x_{n,p}^{(R)}|_{θ=0}=r₁ƒ(X_{n,p}^{(A)}−d_{c})/Z_{n,p}^{(A)} denotes the x-coordinate of x_{n,p}^{(R)} when the convergence angle θ is zero.

The geometric image compensation in Equation 19 may be performed by calculating a new coordinate x_{n,p}^{(cR)}=λ[(c^{(R)}|_{θ,x}_{_{n,p}}(R))·x_{n,p}^{(R)}, y_{n,p}^{(R)},1]^{T} by multiplying x_{n,p}^{(R)} of the 2D point x_{n,p}^{(R)}=λ[x_{n,p}^{(R)}, y_{n,p}^{(R)}, 1]^{T} on the right image 720 by c^{(R)}|ₓ_{_{n,p}}(R)_{, θ}, and then moving x_{n,p}^{(R)} to x_{n,p}^{(cR)}. Then, the 2D point x_{n,p}^{(R)} of when the stereo 3D images are acquired by the stereo cameras of which the convergence angle is zero is approximated by x_{n,p}^{(cR)}.

In Equation 18, by approximating sin θ and cosθ to θ and 1, respectively, when θ≈0 based on Taylor series, and by assuming |x_{n,p}^{(R)}|>>|d_{c}|, the compensation variable c^{(R)}|_{θ,x}_{_{n,p}}(R) may be calculated as shown in Equation 20.

$${c}^{( R )} {\vert}_{θ , {x}_{n , p}^{( R )}} {=}^{Δ} ( {x}_{n , p}^{( R )} {\vert}_{θ = 0} ) / ( {x}_{n , p}^{( R )} ) \text{?} \approx ( 1 - \frac{{X}_{n , p}^{( A )}}{{Z}_{n , p}^{( A )}} θ ) / ( 1 + \frac{{Z}_{n , p}^{( A )}}{{X}_{n , p}^{( A )}} \cdot θ ) \\ \text{?} \text{indicates text missing or illegible when filed} \qquad [ Equation 20 ]$$

Furthermore, when θ≈0 is satisfied, X_{n,p}^{(A)}/Z_{n,p}^{(A)} may be approximated by x_{n,p}^{(A)}/ƒ. Accordingly, C^{(R)}|θ,x_{_{n,p}}(R) may be expressed by Equation 21.

$${c}^{( R )} {\vert}_{θ , {x}_{n , p}^{( R )}} \approx ( 1 - \frac{{x}_{n , p}^{( R )}}{f} \cdot θ ) / ( 1 + \frac{f}{{x}_{n , p}^{( R )}} \cdot θ ) \qquad [ Equation 21 ]$$

In a similar manner, when the convergence angle of the left camera is −θ, the geometrical image compensation at the left image 710 may be performed as shown in Equation 22.

$${x}_{n , p}^{( cL )} = {T}_{c}^{( L )} {x}_{n , p}^{( L )} \cdot ( \begin{matrix}{T}_{c}^{( L )} = [ \begin{matrix}{c}^{( R )} {\vert}_{( - θ ) , {x}_{n , p}^{( L )}} & 0 & 0 \\ 0 & 1 & 0 \\ 0 & 0 & 1\end{matrix} ] , \\ {c}^{( L )} {\vert}_{θ , {x}_{n , p}^{( L )}} = ( 1 - \frac{{x}_{n , p}^{( L )}}{f} \cdot ( - θ ) ) / ( 1 + \frac{f}{{x}_{n , p}^{( R )}} \cdot ( - θ ) . )\end{matrix} ) \qquad [ Equation 22 ]$$

According to the geometric image compensation for reducing the distortion resulting from the convergence angle of the stereo cameras, new coordinates of the points in the stereo 3D images may be calculated simply according to the convergence angle θ and the x-coordinate of the point on the image, and the estimation of dense disparity field or the 3D reconstruction are not required.

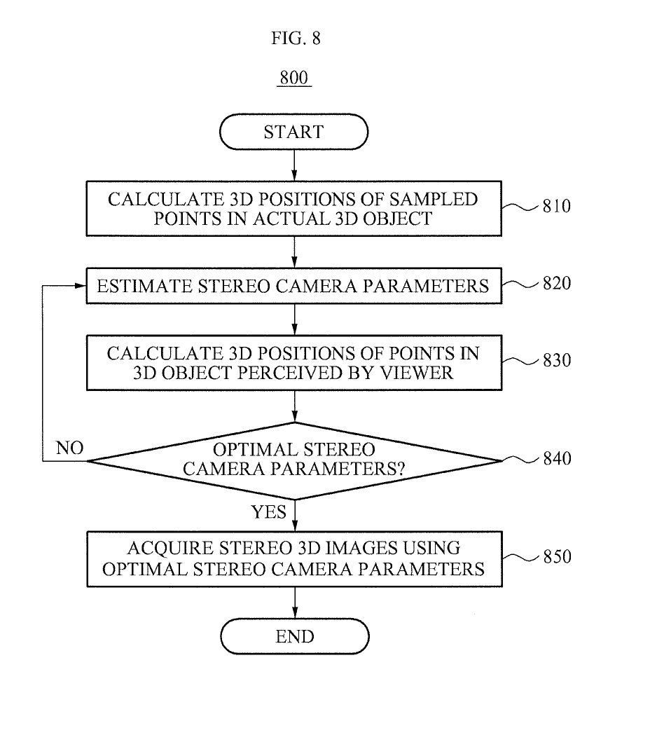

FIG. 8 is a flowhchart illustrating an image processing method 800 according to an embodiment of the present invention. In operation 810, the first calculation unit 110 may calculate the first position, that is, the 3D position of the at least one first point in the actual 3D object in units of an image block pair, using a horizontal block matching.

In operation 820, the determination unit 130 may determine the at least one parameter related to the transmission end, for example, the optimal stereo camera parameters to for minimizing the difference between the first position and the second position.

In operation 830, the second calculation unit 120 of the image processing apparatus may receive the second parameters, that is, the viewer environment parameters, from the second control unit 150, and may calculate the second position of the at least one second point corresponding to the first point in the 3D object perceived by the viewer, according to the given first parameters.

In operation 840, the determination unit 130 may determine whether the first parameters are the optimal parameters. If the first parameters are not the optimal parameters during the minimization, the flow goes to operation 820. Through these steps, the first parameters can be determined as the optimal values for minimizing the difference between the first position and the second position.

When the optimal stereo camera parameters are determined, the first control unit 140 may set the stereo camera parameters to the optimal parameters, acquire the new stereo 3D images, and transfer the acquired stereo 3D images to the receiving end, in operation 850.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple to processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods to described above, or vice versa.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An image processing apparatus comprising:
a first calculation unit to calculate a first position of at least one first point sampled from an actual 3-dimensional (3D) object to be acquired as stereo 3D images;
a second calculation unit to calculate a second position of at least one second point of a receiving end corresponding to the first point, using at least one second parameter related to the receiving end provided with the 3D image; and
a determination unit to determine at least one first parameter related to a transmission end to acquire and provide the stereo 3D images to the receiving end so that a difference between the first position and the second position is minimized.

2. The image processing apparatus of claim 1, wherein at least one of the first position and the second position is a relative position with respect to a reference position in a 3D space.

3. The image processing apparatus of claim 1, wherein the at least one first parameter comprises at least one selected from a baseline, a focal length, a convergence angle, a virtual baseline, and an acquisition distance which are related to the transmission end.

4. The image processing apparatus of claim I, wherein the at least one second parameter comprises at least one selected from a screen size, a viewing distance, a distance between eyes of a viewer, and a viewer position which are related to the receiving end.

5. The image processing apparatus of claim 1, further comprising:
a first control unit to acquire the stereo 3D images by adjusting a camera related to the transmission end based on the at least one first parameter.

6. The image processing apparatus of claim 1, further comprising a second control unit to receive the at least one second parameter from the receiving end and transfer the at least one second parameter to the second calculation unit.

7. The image processing apparatus of claim 1, further comprising a second control unit to measure the at least one second parameter using at least one of the stereo 3D images and depth information, which are transmitted from the receiving end, and to transfer the at least one second parameter to the second calculation unit.

8. The image processing apparatus of claim 1, wherein the determination unit determines the at least one first parameter by obtaining a solution of an objective function that minimizes the difference between the first position and the second position.

9. The image processing apparatus of claim 8, wherein the determination unit obtains the solution of the objective function by selecting part of the at least one first point, when a number of the at least one first point being sampled is larger than a sum of a number of the at least one first parameter and a number of the at least one second parameter.

10. The image processing apparatus of claim 9, wherein the determination unit excludes at least one outlier during the selection.

11. The image processing apparatus of claim 1, wherein the second calculation unit calculates the second position based on geometric image compensation so as to reduce a distortion resulting from a convergence angle of a camera related to the transmission end.

12. The image processing apparatus of claim I, wherein the determination unit determines the at least one first parameter by adding at least one of a disparity control term and a parameter change control term to an objective function and obtaining a solution.

13. An image processing method comprising:
calculating a first position of at least one first point sampled from an actual 3-dimensional (3D) object to be acquired as stereo 3D images;
calculating a second position of at least one second point of a receiving end corresponding to the first point, using at least one second parameter related to the receiving end provided with the stereo 3D images; and
determining at least one first parameter related to a transmission end to acquire and provide the stereo 3D images to the receiving end so that a difference between the first position and the second position is minimized.

14. The image processing method of claim 13, wherein at least one of the first position and the second position is a relative position with respect to a reference position in a 3D space.

15. The image processing method of claim 13, wherein the at least one first parameter comprises at least one selected from a baseline, a focal length, a convergence angle, a virtual baseline, and an acquisition distance which are related to the transmission end.

16. The image processing method of claim 13, wherein the at least one second parameter comprises at least one selected from a screen size, a viewing distance, a distance between eyes of a viewer, and a viewer position which are related to the receiving end.

17. The image processing method of claim 13, further comprising:
acquiring the stereo 3D images by adjusting a camera related to the transmission end based on the at least one first parameter.

18. The image processing method of claim 13, further comprising:
measuring the at least one second parameter using at least one of the stereo 3D images and depth information, which are transmitted from the receiving end, and to transfer the at least one second parameter to the second calculation unit.

19. The image processing method of claim 13, wherein the determining comprises determining the at least one first parameter by obtaining a solution of an objective function that minimizes the difference between the first position and the second position.

20. A non-transitory computer-readable recoding medium storing a program to cause a computer to execute an image processing method, wherein the image processing method comprises:
calculating a first position of at least one first point sampled from an actual 3-dimensional (3D) object to be acquired as a stereo 3D images;
calculating a second position of at least one second point of a receiving end corresponding to the first point, using at least one second parameter related to the receiving end provided with the stereo 3D images; and
determining at least one first parameter related to a transmission end to acquire and provide the stereo 3D images to the receiving end so that a difference between the first position and the second position is minimized.
